(19) United States
(12) Patent Application Publication
(10) Pub. No.: US 2012/0112133 A1
(43) Pub. Date: May 10, 2012

(54) POLYURETHANE MATERIALS COMPRISING CARBON NANOTUBES

(75) Inventors: Stefan Bahnmüller, Kurten (DE); Helmut Meyer, Odenthal (DE); Dirk Dijkstra, Koln (DE); Wolfgang Henning, Kreuzau (DE); Cornelis Eme Koning, DJ Brussum (NL); Jan Hein Van Steenis, Dorsten (DE); Steffan Franciscus Marjo Mulders, AM Veulen (NL)

(73) Assignee: Bayer MaterialScience AG, Leverkusen (DE)

(21) Appl. No.: 13/255,931

(22) PCT Filed: Mar. 5, 2010
(86) PCT No.: PCT/EP2010/001397

§ 371 Date: Jan. 17, 2012

(30) Foreign Application Priority Data
Mar. 13, 2009 (DE) 10 2009 012 674.0

(51) Int. Cl. H01B 1/24; B82Y 40/00; B82Y 30/00

(52) U.S. Cl. 252/511; 977/742; 977/842; 977/932

(57) ABSTRACT

The invention relates to semicrystalline polyurethane (PU) compositions which have been filled with carbon nanotubes (CNTs) and have improved electrical properties, and which are obtainable on the basis of water-based polyurethane-CNT mixtures. The invention further relates to a process for producing the polyurethane compositions, in which water-based polyurethane latices are mixed with carbon nanotubes dispersed in water. The invention further relates to films produced by pressurized injection moulding processes or processing of casting solutions.

The invention relates to semicrystalline polyurethane (PU) compositions which have been filled with carbon nanotubes (CNTs) and have improved electrical properties, and which are obtainable on the basis of water-based polyurethane-CNT mixtures. The invention further relates to a process for producing the polyurethane compositions, in which water-based polyurethane dispersions are mixed with carbon nanotubes dispersed in water. The invention further relates to films produced by pressing processes or processing of casting solutions.

Semicrystalline polyurethanes according to this invention are polyurethanes or mixtures of polyurethanes which have, in the DSC analysis, a melting or crystallization peak which corresponds to a melting enthalpy of at least 5 J/g, preferably of 20 J/g and more preferably of 40 J/g.

Carbon nanotubes are a high-tensile, light, electrically conductive material which has gained enormous attention in recent times, especially in relation to the use thereof in polymer mixtures.

According to the prior art, carbon nanotubes are understood to mean principally cylindrical carbon tubes with a diameter between 3 and 100 nm, and a length which is several times the diameter. These tubes consist of one or more layers of ordered carbon atoms and have a different core in terms of morphology. These carbon nanotubes are also referred to, for example, as “carbon fibrils” or “hollow carbon fibres”.

Carbon nanotubes have been known in the technical literature for some time. Although Iijima (publication: S. Iijima, Nature 354, 56-58, 1991) is generally considered to have discovered nanotubes, these materials, especially fibrous graphite materials with several graphite layers, have been known since the 1970s or early 1980s. Tates and Baker (GB 1469930A1, 1977 and EP 56004 A2) described, for the first time, the deposition of very fine fibrous carbon from the catalytic decomposition of hydrocarbons. However, the carbon filaments produced on the basis of short-chain hydrocarbons are not characterized in detail in relation to their diameter.

Typical structures of these carbon nanotubes are those of the cylinder type. The cylindrical structures are divided between the single-wall monocarbon nanotubes and the multiwall cylindrical carbon nanotubes. Common processes for production thereof are, for example, arc discharge processes, laser ablation, chemical deposition from the vapour phase (CVD process) and catalytic chemical deposition from the vapour phase (CCVD process).

Iijima, Nature 354, 1991, 56-8 discloses the formation of carbon tubes in an arc discharge process, which consist of two or more graphene layers and are rolled up to a seamlessly closed cylinder and are nested one inside another. Depending on the rollup vector, chiral and achiral arrangements of the carbon atoms are possible in relation to the longitudinal axis of the carbon fibres.

Structures of carbon tubes in which a single continuous graphene layer (scroll type) or interrupted graphene layer (onion type) is the basis for the construction of the nanotubes were described for the first time by Bacon et al., J. Appl. Phys. 34, 1960, 283-90. The structure is referred to as scroll-type. Later, corresponding structures were also found by Zhou et al., Science, 263, 1994, 1744-47 and by Lavin et al., Carbon 40, 2002, 1123-30.

The development of production processes on a larger scale, especially for multiwall carbon nanotubes (MWNTs) is making the use of this material ever more attractive. In order to minimize the amount of additives, the use of single-wall carbon nanotubes (SWNTs) would be preferable, but these are not available on a larger scale.

An important field of application is use as additives for polymers. Use as an additive can lead to lightweight materials which are easier to handle and to modify. In order to be able to exploit the advantages of the properties of carbon nanotubes, these should if at all possible be present as isolated tubes in the composite. This is difficult in principle because the strong van der Waals forces between the carbon nanotubes have to be broken. The energy needed for this purpose can be expended by mechanical energy input, for example in the case of extrusion by ball mills or by the use of ultrasound. Composites comprising polymers can be produced by mixing carbon nanotubes and polymers (or prepolymers) together, for which the use of organic solvents, water or dispersions in water (latices) is also an option.

The latex systems appear to be the most promising, since the carbon nanotubes here are conserved to a greater degree than in the case of mechanical methods. The use of latex systems is environmentally friendly and avoids the difficulties arising from high-viscosity technology in the course of processing.

The treatment of carbon nanotubes with, for example, nitric acid leads to the removal of impurities to form oxygen-containing groups at the surface of the carbon nanotubes. This oxidation additionally facilitates the dispersion of the carbon nanotubes in water or other solvents, and a further functionalization of the carbon nanotubes can improve the interaction between polymer and carbon nanotubes. However, the important properties of the carbon nanotubes suffer from such a chemical aftertreatment.

A multitude of applications of carbon nanotubes in different polymers have been described, but there are comparatively few descriptions of incorporation into polyurethanes. One reason for this might be the daunting variety of these elastomer components. They consist typically of an adjustable ratio of hard and soft segments, both of which may either be crystalline or amorphous. Polyurethanes are typically available as polymers in the form of prepolymers or water-based systems, which enables a multitude of options for production of nanocomposites.

The document DE 10 2004 010 455 describes compositions composed of thermoplastic polyurethanes, which comprise carbon nanotubes and are produced by mixing thermoplastic polyurethanes and multiwall carbon nanotubes in an extruder with subsequent processing in an injection moulding process. A comparable method for producing polyurethane fibres which comprise functionalized MWNTs is also described by Chen et al. (Composites Sci. Tech. 66, 3029-3034, 2006). Untreated and acid-treated MWNTs were also incorporated into polymer composites using the latex method, in which the polyurethane was formed in situ and compared to a conventional mixing method. The functionalization of the nanotubes clearly led here to improved electrical and antistatic properties, compared to untreated carbon nanotubes.

The document WO 2004/072159 describes thermoplastics comprising carbon nanotubes, in which a comparatively small amount of CNT is needed to achieve electrical percolation in thermoplastics. In this case, single-wall carbon nanotubes (SWNTs) were used. the document WO 2007/121780 describes polymer mixtures which comprise both high molecular weight and low molecular weight fractions of the same polymer for obtaining electrically conductive polymer composites employing latex technology in the production of such mixtures.

Körner et al. (Polymer 46, 4405-4420, 2005) describe a process for grinding MWNTs and subsequently mixing them with semicrystalline polyurethane in THF to study the crystallization. The percolation threshold here is again comparatively low. THF solutions of carbon nanotubes and polyurethanes using ultrasound treatment were described by Chen et al. (Macromol. Rapid Commun. 26, 1763-1767, 2005). Using this process, composite films were obtained.

By treatment of SWNTs or MWNTs by grinding in a ball mil in polyols using a dispersant with addition of further chemicals to this mixture to produce a prepolymer, and subsequent curing, it was possible to obtain nanocomposites which have an improved thermal stability. This was described by Xia et al. (Soft Matter 1, 386-394, 2005). The mechanical properties were improved by the use of MWNTs. A stirring process for dispersing the carbon nanotubes was found to be much less effective.

Kuan et al. (Composites Sci. Tech. 65, 1703-1710, 2005) use amino-functionalized MWNTs and mix them with prepolymers with high shear forces or using ultrasound to obtain composites. A comparable method of Jung et al. (Macromol Rapid Communication 27, 126-131, 2006) uses, for carboxylate-functionalized MWNTs which were added to prepolymers with stirring, subsequent curing in a melt press. The carbon nanotubes here functioned as covalent crosslinkers.

In a comparison between untreated and functionalized MWNTs, Sahoo et al. (Macromol. Chem. Phys. 207, 1773-1780, 2006) used ultrasound to disperse the carbon nanotubes in DMF, both with and without dispersant. After stirring such a solution with polyurethane, the mixture was treated by means of ultrasound and then cast to films. Aniline-functionalized MWNTs were mixed at high shear rates with hydrophilic polyurethanes in DMF, as described by Montal et al. (Polymer Chemistry 43, 3973-3985, 2005), with the purpose of obtaining a coating composition permeable to water vapour.

Xia et al. (Macromol. Chem. Phys. 207, 1945-1952, 2006) used mixtures of polyurethanes and functionalized MWNTs, treated them repeatedly with ultrasound and mixed them with a polyol in a ball mill, and then ended the formation of the polyurethane. Even though the stability of the intermediate MWNT-polymer dispersion was improved, there were no great improvements with regard to the final properties compared to unfunctionalized MWNTs. Buffa et al. (Journal of Polymer Science, Polymer Physics 45, 490-501, 2007) showed that hydroxy-functionalized SWNTs were subject to a serious loss of conductivity, but, on the other hand, gave composites with a slightly increased modulus using a solution-based production method.

It is an object of the present invention to provide a method for producing electrically conductive polyurethane composites. It has been found that such PU composites can be produced by latex technology when the polyurethane polymer is based on semicrystalline PU.

The present invention relates to semicrystalline polyurethane compositions which are filled with carbon nanotubes and have improved electrical properties, which are based on water-based polyurethane-CNT mixtures. To produce these composites, water-based PU latices are mixed with carbon nanotubes dispersed in water and then, for example, processed to films, which are produced by pressing or casting processes.

The invention provides an electrically conductive polyurethane composition comprising at least one polyurethane polymer and carbonaceous nanoparticles, characterized in that the polymer material has a substantial portion of semicrystalline polyurethane, preferably at least 10% by weight of semicrystalline polyurethane, and the carbonaceous nanoparticle comprises at least 20%, preferably at least 50% and more preferably 100% carbon nanotubes.

Preference is given to a polyurethane composition in which the proportion of carbonaceous nanoparticles is at least 0.1% by weight, preferably at least 1% by weight and more preferably at least 2% by weight.

Preference is also given to a polyurethane composition in which the proportion of carbonaceous nanoparticles is not more than 8% by weight, preferably not more than 6% by weight, more preferably not more than 5% by weight and especially preferably not more than 3% by weight.

The conductivity of the particularly preferred embodiment of the polyurethane composition is at least 1·10⁻⁵ S/cm, preferably at least 1·10⁻⁴ S/cm and more preferably at least 1·10⁻³ S/cm.

Particular preference is also given to a polyurethane composition which is characterized in that it comprises 100% carbon nanotubes as carbonaceous nanoparticles, and the proportion of the carbon nanotubes in the composition is not more than 5% by weight.

More preferred is a polyurethane composition formed from
A. at least one difunctional aliphatic or aromatic polyesterpolyol with a molecular weight of 400 to 5000 g/mol,
B. optionally difunctional or higher-functionality polyol components with a molecular weight of 62 to 399,
C. at least one di- or polyisocyanate component and
D. optionally one or more aminic chain extenders,
   characterized in that the polymer is semicrystalline after drying and has, in the DSC analysis, a melting or crystallization peak which corresponds to a melting enthalpy of at least 5 J/g, preferably of 20 J/g and more preferably of 40 J/g.

Particular preference is further given to a polyurethane composition which is characterized in that the semicrystalline polyurethanes are based on polyurethane latices.

The invention also provides a process for producing electrically conductive polyurethane compositions, especially the novel polyurethane compositions described above, from polyurethane polymers and carbonaceous nanoparticles, characterized in that
a) an aqueous dispersion of carbon nanoparticles is prepared,
b) the dispersion of the carbonaceous nanoparticles is mixed with an aqueous polyurethane dispersion,
c) water is removed from this mixture,
d) the dried product from step c) is hardened by applying heat,
   the polyurethane dispersion being based on substantial amounts of semicrystalline polyurethane, especially a minimum content of 20% by weight of semicrystalline polyurethane.

Preference is given to a process which is characterized in that, in the preparation of the aqueous dispersion of the carbonaceous nanoparticles, a surface-active substance is added as a dispersant.

The surface-active substance is especially selected from the group of the hydrocarbon sulphates or sulphonates, such as sodium dodecylsulphonate (SDS), the polyalkylene oxide-based dispersants, the water-dispersible pyrrolidones, or block copolymers which are surface-active in an aqueous medium.

In a preferred process, the aqueous dispersion is prepared in step a) by employing ultrasound.

The invention further provides for the use of the novel polyurethane composition for producing coatings in motor vehicle construction or for housings of electrical appliances.

In the context of the invention, carbon nanotubes are all single-wall or multiwall carbon nanotubes of the cylinder type, scroll type or with an onion-type structure. Preference is given to multiwall carbon nanotubes of the cylinder type, scroll type or mixtures thereof.

Particular preference is given to using carbon nanotubes with a ratio of length to external diameter of greater than 5, preferably greater than 100.

The carbon nanotubes are more preferably used in the form of agglomerates, in which case the agglomerates especially have a mean diameter in the range from 0.05 to 5 mm, preferably 0.1 to 2 mm and more preferably 0.2-1 mm.

The carbon nanotubes for use more preferably have essentially a mean diameter of 3 to 100 nm, preferably 5 to 80 nm and more preferably 6 to 60 nm.

In contrast to the known scroll-type CNTs mentioned at the outset, which have only one continuous or interrupted graphene layer, the applicant has also found CNT structures which consist of several graphene layers which are present combined to a stack and rolled up (multiscroll type). These carbon nanotubes and carbon nanotube agglomerates thereof are, for example, the subject of German patent application with official reference number 102007044031.8, which was yet to be published at the priority date of the present application. The contents thereof are hereby incorporated into the disclosure-content of this application with regard to the CNTs and production thereof. The behaviour of this CNT structure with respect to the simple scroll-type carbon nanotubes is comparable to that of the structure of multiwall cylindrical monocarbon nanotubes (cylindrical MWNTs) with respect to the structure of the single-wall cylindrical carbon nanotubes (cylindrical SWNTs).

Unlike the case of the onion-type structures, the individual graphene or graphite layers in these carbon nanotubes, viewed in cross section, apparently run continuously from the centre of the CNTs up to the outer edge without interruption. This can enable, for example, improved and more rapid intercalation of other materials in the tube framework, since more open edges are available as an entry zone for the intercalates compared to CNTs with a simple scroll structure (Carbon 34, 1996, 1301-3) or CNTs with an onion-type structure (Science 263, 1994, 1744-7).

The methods known nowadays for producing carbon nanotubes include arc discharge, laser ablation and catalytic processes. Many of these processes form soot, amorphous carbon and fibres with high diameter as by-products. The catalytic processes can be divided between deposition onto supported catalyst particles, and deposition on to metal sites formed in situ with diameters in the nanometer range (known as flow processes). In the case of production by means of the catalytic deposition of carbon from hydrocarbons which are gaseous under reaction conditions (hereinafter, CCVD: Catalytic Carbon Vapour Deposition), possible carbon donors mentioned include acetylene, methane, ethane, ethylene, butane, butene, butadiene, benzene and further carbon-containing reactants. Preference is therefore given to using CNTs obtainable from catalytic processes.

The catalysts generally include metals, metal oxides or decomposable or reducible metal components. For example, the prior art mentions, as metals for the catalyst, Fe, Mo, Ni, V, Mn, Sn, Co, Cu and further transition group elements. Although the individual metals usually have a tendency to promote the formation of carbon nanotubes, high yields and low proportions of amorphous carbons are, according to the prior art, advantageously achieved with those metal catalysts based on a combination of the abovementioned metals. CNTs obtainable using mixed catalysts should consequently be used with preference.

Particularly advantageous catalyst systems for producing CNTs are based on combinations of metals or metal compounds which comprise two or more elements from the group of Fe, Co, Mn, Mo and Ni.

Experience has shown that the formation of carbon nanotubes and the properties of the tubes formed depend in a complex manner on the metal component used as a catalyst or a combination of two or more metal components, any catalyst support material used and the interaction between catalyst and support, the reactant gas and partial pressure, an addition of hydrogen or further gasses, the reaction temperature and the residence time or the reactor used.

A process for use with particular preference for producing carbon nanotubes is known from WO 2006/050903 A2.

In the different processes mentioned so far, using different catalyst systems, carbon nanotubes of various structures are produced, which can be taken from the process predominantly as carbon nanotube powders.

Carbon nanotubes which are more preferentially suitable for the invention are obtained by processes whose principles are described in the following literature references:

The production of carbon nanotubes with diameters less than 100 nm was described for the first time in EP 205 556 B1. For the production, light (i.e. short- and medium-chain aliphatic or mono- or bicyclic aromatic) hydrocarbons and an iron-based catalyst are used, over which carbon carrier compounds are decomposed at a temperature above 800-900° C.

WO86/03455A1 describes the production of carbon filaments which have a cylindrical structure with a constant diameter of 3.5 to 70 nm, an aspect ratio (ratio of length to diameter) of greater than 100 and a core region. These fibrils consist of many continuous layers of ordered carbon atoms which are arranged concentrically around the cylindrical axis of the fibrils. These cylinder-type nanotubes were produced by a CVD process from carbon compounds by means of a metallic particle at a temperature between 850° C. and 1200° C.

WO2007/093337A2 discloses another process for producing a catalyst which is suitable for the production of conventional carbon nanotubes with cylindrical structure. In the case of use of this catalyst in a fixed bed, higher yields of cylindrical carbon nanotubes with a diameter in the range from 5 to 30 nm are obtained.

A completely different route to the production of cylindrical carbon nanotubes was described by Oberlin, Endo and Koyam (Carbon 14, 1976, 133). This involves converting aromatic hydrocarbons, for example benzene, over a metal catalyst. The carbon nanotubes formed exhibit a well-defined, graphitic hollow core which has approximately the diameter of the catalyst particle, on which further carbon with a lesser degree of graphitic order is present. The entire carbon nanotubes can be graphitized by treatment at high temperature (2500° C.-3000° C.).

Most of the abovementioned processes (with arc discharge, spray pyrolysis or CVD) are nowadays used to produce carbon nanotubes. However, the production of single-wall cylindrical carbon nanotubes is very complex in apparatus terms and proceeds, according to the known processes, with very low formation rate and often also with many side reactions which lead to a high proportion of undesired impurities, i.e. the yield of such processes is comparatively low. Therefore, the production of such carbon nanotubes, even nowadays, is still extremely technically complex, and they are therefore used for highly specialized applications in particular, in small amounts. Their use for the invention is, however, conceivable, but less preferred than the use of multiwall CNTs of the cylinder or scroll type.

The production of multiwall carbon nanotubes in the form of seamless cylindrical nanotubes nested one inside another, or else in the form of the scroll or onion structures described, is nowadays effected commercially in relatively large amounts, predominantly using catalytic processes. These processes typically exhibit a higher yield than the abovementioned arc discharge and other processes, and are nowadays typically performed on the kg scale (a few hundred kilos/day globally). The multiwall carbon nanotubes thus produced are generally less expensive by some way than the single-wall nanotubes and are therefore used, for example, as a performance-enhancing additive in other materials.

Preference is given to using, as the oxidizing agent for the functionalization of the carbon nanotubes, an oxidizing agent from the group of: nitric acid, hydrogen peroxide, potassium permanganate and sulphuric acid, or a possible mixture of these agents. Preference is given to using nitric acid or a mixture of nitric acid and sulphuric acid, particular preference to using nitric acid.

The dispersion of carbon nanotubes in water can be achieved by means of ultrasound processes in the presence of surface-active substances. A widespread surface-active substance is sodium dodecylsulphate, but it is also possible here to use other ionic or nonionic surface-active compounds or dispersing assistants, and optionally also polymeric dispersing assistants. Examples mentioned are: poly-N-vinylpyrrolidone, sulphonated polystyrene, polyacrylic acid, carboxymethylcellulose, hydroxyethylcellulose, and other comparable compounds for producing homogeneous dispersions of carbon nanotubes. Instead of the ultrasound method, it is optionally also possible to use other known processes for producing dispersions, for example using ball mills, by means of high-shear dispersion processes or using three-roll calendar methods.

The conditions of the preferred ultrasound treatment can be optimized further for each batch of carbon nanotubes, for example by employing an initially low total content of carbon nanotubes at a high dose of ultrasound. The optimal ultrasound treatment time can also be determined by monitoring the UV absorption of the dispersion over time. It is additionally possible to determine the maximum proportion by weight of carbon nanotubes and the minimum ratio of SCS to CNT by observing the CNT content at which dispersion continues to rise in a linear manner, full dispersion being determined by transmission electron microscopy (TEM).

Particularly suitable semicrystalline polyurethanes in the context of the invention are those formed from
A. at least one difunctional aliphatic or aromatic polyesterpolyol with a molecular weight of 400 to 5000 g/mol,
B. optionally difunctional or higher-functionality polyol components with a molecular weight of 62 to 399,
C. at least one di- or polyisocyanate component and
D. optionally one or more aminic chain extenders,
   which are based on polyurethane latices, characterized in that the polymer is partly crystalline after drying and has, in the DSC analysis, a melting or crystallization peak which corresponds to a melting enthalpy of at least 5 J/g, preferably of 20 J/g and more preferably of 40 J/g.

The inventive aqueous dispersions comprise a mixture of 80 to 99.9% by weight, preferably 90 to 99.8% by weight, more preferably 95 to 99.5% by weight and most preferably 96 to 99.0% by weight of the aqueous polyurethane or polyurethane urea dispersion A), and 0.1 to 20% by weight, preferably 0.2 to 10% by weight, more preferably 0.5 to 5% by weight and most preferably 1 to 4% by weight of carbon nanotubes.

Suitable difunctional aliphatic polyesterpolyols A include especially linear polyesterdiols, as can be prepared in a known manner from aliphatic or cycloaliphatic dicarboxylic acids, for example succinic acid, methylsuccinic acid, glutaric acid, adipic acid, pimelic acid, suberic acid, azelaic acid, sebacic acid, nonanedicarboxylic acid, decanedicarboxylic acid, tetrahydrophthalic acid, hexahydrophthalic acid, cyclohexanedicarboxylic acid, maleic acid, fumaric acid, malonic acid or mixtures thereof with polyhydric alcohols, for example ethanediol, di-, tri-, tetraethylene glycol, 1,2-propanediol, di-, tri-, tetrapropylene glycol, 1,3-propanediol, 1,4-butanediol, 1,3-butanediol, 2,3-butanediol, 1,5-pentanediol, 1,6-hexanediol, 2,2-dimethyl-1,3-propanediol, 1,4-dihydroxycyclohexane, 1,4-dimethylolcyclohexane, 1,8-octanediol, 1,10-decanediol, 1,12-dodecanediol or mixtures thereof. Instead of the free polycarboxylic acid, it is also possible to use the corresponding polycarboxylic anhydrides or corresponding polycarboxylic esters of lower alcohols or mixtures thereof to prepare the polyesters.

Preference is given to difunctional aliphatic polyesterpolyols A based on succinic acid, methylsuccinic acid, glutaric acid, adipic acid or maleic acid, and 1,3-propanediol, 1,4-butanediol or 1,6-hexanediol.

Particular preference is given to difunctional aliphatic polyesterpolyols A based on adipic acid and 1,4-butanediol or 1,6-hexanediol.

Very particular preference is given to difunctional aliphatic polyesterpolyols A based on adipic acid and 1,4-butanediol.

The molecular weight of the difunctional aliphatic polyesterpolyol A is between 400 and 5000 g/mol, preferably between 1500 and 3000 g/mol and more preferably between 1900 and 2500 g/mol.

Optionally, it is possible to use, at proportions by weight 0 to 50%, preferably of 0 to 40% and more preferably of 0 to 30%, further difunctional or higher-functionality polyols as component A. These are compounds having at least two hydrogen atoms reactive towards isocyanates and a mean molecular weight of 400 to 5000 daltons. Examples of suitable formation components are polyethers, polyesters, polycarbonates, polylactones or polyamides. The polyols preferably have 2 to 4 and more preferably 2 to 3 hydroxyl groups. Mixtures of different compounds of this kind are also useful.

Useful polyesterpolyols include especially linear polyesterdiols or else lightly branched polyesterpolyols, as can be prepared in a known manner from aliphatic, cycloaliphatic or aromatic di- or polycarboxylic acids, for example succinic acid, methylsuccinic acid, glutaric acid, adipic acid, pimelic acid, suberic acid, azelaic acid, sebacic acid, nonanedicarboxylic acid, decanedicarboxylic acid, terephthalic acid, isophthalic acid, o-phthalic acid, tetrahydrophthalic acid, hexahydrophthalic acid, cyclohexanedicarboxylic acid, maleic acid, fumaric acid, malonic acid or trimellitic acid, and acid anhydrides such as o-phthalic anhydride, trimellitic anhydride or succinic anhydride, or mixtures thereof, with polyhydric alcohols, for example ethanediol, di-, tri-, tetraethylene glycol, 1,2-propanediol, di-, tri-, tetrapropylene glycol, 1,3-propanediol, butanediol-1,4, butanediol-1,3, butanediol-2,3, pentanediol-1,5, hexanediol-1,6,2,2-dimethyl-1,3-propanediol, 1,4-dihydroxycyclohexane, 1,4-dimethylolcyclohexane, octanediol-1,8, decanediol-1,10, dodecanediol-1,12 or mixtures thereof, optionally with additional use of higher-functionality polyols such as trimethylolpropane, glycerol or pentaerythritol. Useful polyhydric alcohols for preparing the polyesterpolyols of course also include cycloaliphatic and/or aromatic di- and polyhydroxyl compounds. Instead of the free polycarboxylic acid, it is also possible to use the corresponding polycarboxylic anhydrides or corresponding polycarboxylic esters of lower alcohols or mixtures thereof to prepare the polyesters.

It will be appreciated that the polyesterpolyols may also be homo- or copolymers of lactones, which are preferably obtained by addition of lactones or lactone mixtures, such as butyrolactone, ε-caprolactone and/or methyl-ε-caprolactone, onto the suitable difunctional and/or higher-functionality starter molecules, for example the low molecular weight polyhydric alcohols mentioned above as formation components for polyesterpolyols. The corresponding polymers of ε-caprolactone are preferred.

Particular preference is given to substantially linear polyesterpolyols which comprise, as formation components, adipic acid and butanediol-1,4 and/or hexanediol-1,6 and/or 2,2-dimethyl-1,3-propanediol.

Polycarbonates having hydroxyl groups are also useful as polyhydroxyl components, for example those which can be prepared by reacting diols such as 1,4-butanediol and/or 1,6-hexanediol with diaryl carbonates, for example diphenyl carbonate, dialkyl carbonates, for example dimethyl carbonate, or phosgene. The at least partial use of polycarbonates having hydroxyl groups can improve the hydrolysis stability of the inventive dispersion adhesives.

Preference is given to polycarbonates which have been prepared by reacting 1,6-hexanediol with dimethyl carbonate.

Suitable polyetherpolyols are, for example, the polyaddition products of the styrene oxides, of ethylene oxide, of propylene oxide, of tetrahydrofuran, of butylene oxide, of epichlorohydrin, and the coaddition and grafting products thereof, and the polyetherpolyols which are obtained by condensation of polyhydric alcohols or mixtures thereof and those obtained by alkoxylation of polyhydric alcohols, or polyfunctional amines and amino alcohols. Polyetherpolyols suitable as formation components A are the homopolymers, copolymers and graft polymers of propylene oxide and of ethylene oxide, which are obtainable by addition of the epoxides mentioned onto low molecular weight di- or triols, as specified above as formation components for polyesterpolyols, or onto higher-functionality low molecular weight polyols, for example pentaerythritol or sugars, or onto water.

Particularly preferred difunctional or higher-functionality polyols are polyesterpolyols, polylactones or polycarbonates, very particular preference being given to polyesterpolyols of the type mentioned above.

Suitable formation components B are difunctional or higher-functionality polyol components having a molecular weight of 62 to 399 daltons, for example polyethers, polyesters, polycarbonates, polylactones or polyamides, provided that they have a molecular weight of 62 to 399 daltons.

Further suitable components are the polyhydric, especially dihydric, alcohols mentioned under B for preparation of the polyesterpolyols.

Preferred components B are ethanediol, diethylene glycol, 1,2-propanediol, dipropylene glycol, 1,3-propanediol, 1,4-butanediol, 1,3-butanediol, 2,3-butanediol, 1,5-pentanediol and 1,6-hexanediol.

Particularly preferred components B are ethanediol, 1,4-butanediol and 1,6-hexanediol.

Suitable formation components C are any desired organic compounds which have at least two free isocyanate groups per molecule. Preference is given to using diisocyanates Y(NCO)2 where Y is a divalent aliphatic hydrocarbon radical having 4 to 12 carbon atoms, a divalent cycloaliphatic hydrocarbon radical having 6 to 15 carbon atoms, a divalent aromatic hydrocarbon radical having 6 to 15 carbon atoms or a divalent araliphatic hydrocarbon radical having 7 to 15 carbon atoms. Examples of such diisocyanates for use with preference are tetramethylene diisocyanate, methylpentamethylene diisocyanate, hexamethylene diisocyanate, dodecamethylene diisocyanate, 1,4-diisocyanatocyclohexane, 1-isocyanato-3,3,5-trimethyl-5-isocyanatomethylcyclohexane, 4,4′-diisocyanatodicyclohexylmethane, 4,4′-diisocyanatodicyclohexylpropane-(2,2), 1,4-diisocyanatobenzene, 2,4-diisocyanatotoluene, 2,6-diisocyanatotoluene, 4,4′-diisocyanatodiphenylmethane, 2,2′- and 2,4′-diisocyanatodiphenylmethane, tetramethylxylylene diisocyanate, p-xylylene diisocyanate, p-isopropylidene diisocyanate, and mixtures consisting of these compounds.

It will be appreciated that it is also possible to use proportions of the higher-functionality polyisocyanates known per se in polyurethane chemistry, or else modified polyisocyanates known per se, having, for example, carbodiimide groups, allophanate groups, isocyanurate groups, urethane groups and/or biuret groups.

Preferred diisocyanates C are aliphatic and araliphatic diisocyanates such as hexamethylene diisocyanate, 1,4-diisocyanatocyclohexane, 1-isocyanato-3,3,5-trimethyl-5-isocyanatomethylcyclohexane, 4,4′-diisocyanatodicyclohexylmethane or 4,4′-diisocyanatodicyclohexylpropane-(2,2), and mixtures consisting of these compounds.

Particularly preferred formation components C are mixtures of hexamethylene diisocyanate (HDI) and 1-isocyanato-3,3,5-trimethyl-5-isocyanatomethylcyclohexane (IPDI).

Suitable aminic chain extenders D are monoamino and/or diamino compounds, chain extenders in the context of the invention also meaning monoamines, which lead to chain termination, and mixtures thereof.

Examples of monoamines are aliphatic and/or alicyclic, primary and/or secondary monoamines such as ethylamine, diethylamine, the isomeric propyl- and butylamines, higher linear-aliphatic monoamines and cycloaliphatic monoamines such as cyclohexylamine. Further examples are amino alcohols, i.e. compounds which contain amino and hydroxyl groups in one molecule, for example ethanolamine, N-methylethanolamine, diethanolamine or 2-propanolamine. Further examples are monoamino compounds which additionally bear sulphonic acid and/or carboxy groups, for example taurine, glycine or alanine.

Examples of diamino compounds are 1,2-ethanediamine, 1,6-hexamethylenediamine, 1-amino-3,3,5-trimethyl-5-aminomethylcyclohexane (isophoronediamine), piperazine, 1,4-diaminocyclohexane or bis(4-aminocyclohexyl)methane. In addition, adipic dihydrazide, hydrazine or hydrazine hydrate are useful. It is also possible to use polyamines such as diethylenetriamine in place of a diamino compound as a formation component.

Further examples are amino alcohols, i.e. compounds which contain amino and hydroxyl groups in one molecule, for example 1,3-diamino-2-propanol, N-(2-hydroxyethyl)ethylenediamine or N,N-bis(2-hydroxyethyl)ethylenediamine.

Examples of diamino compounds with an ionic group, which thus additionally bear sulphonate and/or carboxylate groups, are, for example, the sodium or potassium salts of N-(2-aminoethyl)-2-aminoethanesulphonic acid/-carboxylic acid, of N-(3-aminopropyl)-2-aminoethanesulphonic acid/-carboxylic acid, of N-(3-aminopropyl)-3-aminopropanesulphonic acid/-carboxylic acid, or of N-(2-aminoethyl)-3-aminopropanesulphonic acid/-carboxylic acid. Preference is given to the sodium salt of N-(2-aminoethyl)-2-aminoethanesulphonic acid.

Preferred aminic chain extenders D are diethanolamine, 1,2-ethanediamine, 1-amino-3,3,5-trimethyl-5-aminomethylcyclohexane (isophoronediamine), piperazine, N-(2-hydroxyethyl)ethylenediamine and the sodium salts of N-(2-aminoethyl)-2-aminoethanesulphonic acid/-carboxylic acid.

Particular preference is given to diethanolamine, N-(2-hydroxyethyl)ethylenediamine and the sodium salt of N-(2-aminoethyl)-2-aminoethanesulphonic acid.

The parent polymer of the inventive dispersions contains ionic or potentially ionic groups for hydrophilization, which may be either cationic or anionic in nature. Preference is given to sulphonate and carboxylate groups. Alternatively, it is possible to use those groups which can be converted by salt formation to the aforementioned ionic groups (potentially ionic groups). The hydrophilic groups can be introduced into the polymer via components A, B and/or D. They are preferably introduced via components B or D, more preferably via component D, most preferably via the sodium salt of N-(2-aminoethyl)-2-aminoethanesulphonic acid as the aminic chain extender D.

The polymer is partly crystalline after drying. “Partly crystalline” means that the polymer has, or the polymers have, a degree of crystallization of 5 to 100% and preferably of 20 to 100%. In this context, “crystallinity” means that, in the DSC of the polymers, with rising temperature, a maximum is passed through, which is caused by the melting of regular substructures in the polymer. The melting peak constitutes a kind of fingerprint of the crystalline structure of the polymer. In the case of passage through a melting-crystallization cycle, the melting enthalpy can be determined from the area of the melting of crystallization peak. For the inventive polyurethanes or polyurethane mixtures, it is at least 5 J/g, preferably at least 20 J/g and more preferably at least 40 J/g.

The aqueous polyurethane or polyurethane urea dispersion is preferably prepared by the acetone process. To this end, prepolymers of components A, and if appropriate B and C, are dissolved in acetone and chain-extended with components D. After dispersion with water, the acetone is distilled off. The application and performance of the acetone process is prior art and is known to those skilled in the art.

The invention is illustrated in detail by way of example below using the figures. The figures show:

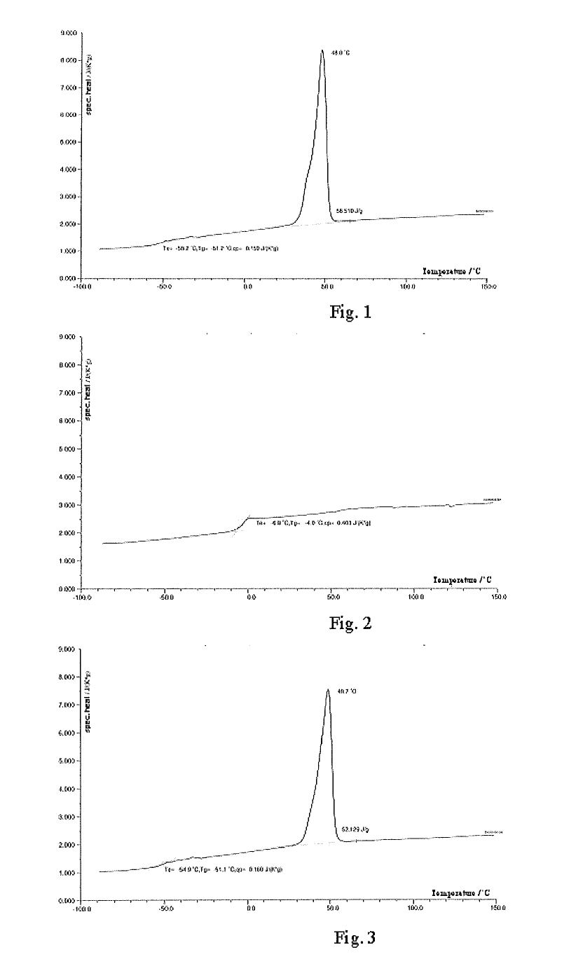

FIG. 1: DSC curve of partly crystalline Dispercoll U56

FIG. 2: DSC curve of amorphous Dispercoll U42

FIG. 3: DSC curve of partly crystalline Dispercoll U54

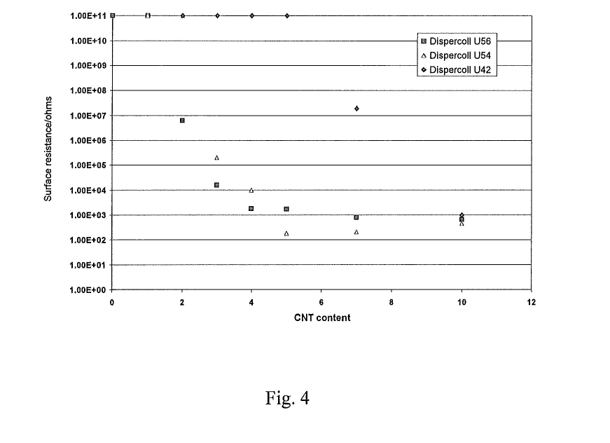

FIG. 4: surface resistance of CNT-filled polyurethane polymers Dispercoll U56, Dispercoll U42, Dispercoll U54 in comparison

### EXAMPLES

### Example 1

80 mg of carbon nanotubes and 20 ml of an aqueous solution of sodium dodecylsulphonate (SDS) (1.0 to 1.5 equivalents by weight in water) were treated with ultrasound at 20 W in a thick-wall bottle until dispersion was complete. The ultrasound treatment was performed with a Sonic Vibracell VC 750 with a cylindrical tip (end diameter 10 mm). To optimize the treatment time, the ultrasound treatment was optimized in preceding experiments. At regular intervals, 20 μl of the carbon nanotube dispersion were drawn off, 3000 μl of water were added, and the mixture was diluted fourfold. The UV absorption of the sample was determined at 262 nm (by means of an HP 8453 UV-VIS spectrometer) until a plateau value was attained.

The mixture was centrifuged at 3500 rpm over half an hour (Varifuge RF, Heraeus Sepatech) and then decanted in order to remove residual solids. The dispersion which was obtained contained more than 95% of the carbon nanotubes (determined gravimetrically).

The dispersed CNTs were then mixed with different amounts of polyurethane latex of the Dispercoll U56 type (semicrystalline low molecular weight polyurethane dispersion based on adipic acid/butanediol polyester, manufacturer: Bayer MaterialScience AG). The DSC curve (Perkin Elmer DSC 7) on a dried Dispercoll U56 film at a heating rate of 20 K/min is given in FIG. 1, and shows a melting or crystallization peak of 58.5 J/g.

The amount of latex and CNT dispersion which was needed for the final composite was mixed within intensive stirring over one hour. Then a Petri dish was placed onto a sand bath (on a Barnstead/Thermolyne Cimarec 3 hotplate) and positioned horizontally. Subsequently, the CNT-latex mixture was introduced. The temperature of the hotplate was set to 60° C. and the film was dried overnight.

The sample was dried for a further day under reduced pressure. The films formed were often detachable easily, but occasionally with significant deformation owing to the strong adhesion of the film to the glass. The use of small amounts of water eased the detachment of the films from the dishes without deformation. After the detachment of the films, they were dried once again under reduced pressure. The film thickness was measured in each case with a mechanical measuring instrument.

The conductivity of the films was determined by means of a two-point test method by means of a Keithley 6512 electrometer, optionally with increased accuracy by a four-point measurement using an additional Keithley 220 current source. For this purpose, four parallel lines of colloidal graphite (1 cm long with line separation 1 cm) were applied as electrodes to the surface of the films.

The conductivity was determined on a 1 cm² area and can be described as follows:

$$\begin{matrix}c \text{(electrical conductivity)} = 1 \text{(length)} / R \text{(electrical resistance)} \cdot \\ A \text{(cross section)} \\ = 1 cm / R \cdot 1 cm \cdot d \\ = 1 / R \cdot d\end{matrix}$$

R was derived by plotting the measured voltage against the preselected current. The film thickness d was determined separately. The results of the analysis are reproduced in Table 1. They show a good electrical conductivity in the CNT-polyurethane mixtures, especially at CNT concentrations exceeding 2% by weight.

TABLE 1

| | | | Conductivity |
|---|---|---|---|
| Polyurethane | CNT/SDS | CNT (%) | (S/cm) |
| Dispercoll U56 | 0 | 0 | 6.7 10⁻⁷ |
| Dispercoll U56 | 0.7 | 1 | 8.9 10⁻⁷ |
| Dispercoll U56 | 0.7 | 2 | 1.2 10⁻⁶ |
| Dispercoll U56 | 0.7 | 3 | 7.8 10⁻³ |
| Dispercoll U56 | 0.7 | 4 | 1.1 10⁻¹ |
| Dispercoll U56 | 0.7 | 5 | 9.2 10⁻¹ |
| Dispercoll U56 | 0.7 | 6 | 2.3 10⁻⁰ |
| Dispercoll U56 | 1 | 1 | 9.1 10⁻⁷ |
| Dispercoll U56 | 1 | 2 | 8.8 10⁻⁷ |
| Dispercoll U56 | 1 | 3 | 6.1 10⁻³ |
| Dispercoll U56 | 1 | 4 | 9.4 10⁻⁴ |
| Dispercoll U56 | 1 | 5 | 1.1 10⁻² |
| Dispercoll U56 | 1 | 6 | 1.0 10⁻⁰ |

### Example 2 (Comparative Example)

The same process as in Example 1 was employed, except that the amorphous Dispercoll U 56 (amorphous, high molecular weight polyurethane dispersion based on phthalic anhydride/hexanediol polyester, manufacturer: Bayer MaterialScience AG) was used as the polyurethane dispersion instead of the semicrystalline Dispercoll U 56. The DSC curve (Perkin Elmer DSC 7) on a dried Dispercoll U42 film at a heating rate of 20 K/min is given in FIG. 2 and does not show any recognizable melting or crystallization peak. The results of the conductivity measurements on the dried films—see Table 2—show a comparatively low electrical conductivity of the composite obtained here, even at a CNT content of 8% by weight.

TABLE 2

| | | | Conductivity |
|---|---|---|---|
| Polyurethane | CNT/SDS | CNT (%) | (S/cm) |
| Dispercoll U42 | 0 | 0 | 6.4 10⁻⁷ |
| Dispercoll U42 | 0.7 | 2 | 1.1 10⁻⁶ |
| Dispercoll U42 | 0.7 | 4 | 1.0 10⁻⁶ |
| Dispercoll U42 | 0.7 | 6 | 9.8 10⁻⁷ |
| Dispercoll U42 | 0.7 | 7 | 2.8 10⁻⁶ |
| Dispercoll U42 | 0.7 | 8 | 4.9 10⁻⁶ |
| Dispercoll U42 | 1 | 2 | 5.3 10⁻⁷ |
| Dispercoll U42 | 1 | 4 | 7.1 10⁻⁷ |
| Dispercoll U42 | 1 | 6 | 8.7 10⁻⁷ |
| Dispercoll U42 | 1 | 7 | 1.3 10⁻⁶ |
| Dispercoll U42 | 1 | 8 | 9.8 10⁻⁶ |

### Example 3

The same process as described in Example 1 was performed, except that semicrystalline Dispercoll U54 (semicrystalline, high molecular weight polyurethane dispersion based on adipic acid/butanediol polyester, manufacture: Bayer MaterialScience AG) which has a higher molecular weight than Dispercoll U56 was used and compared to Dispercoll U56 and Dispercoll U42. The DSC curve (Perkin Elmer DSC 7) on a dried Dispercoll U54 film at a heating rate of 20 K/min is given in FIG. 3 and shows a melting or crystallization peak of 52.1 J/g.

The electrical surface resistance of the films obtained was measured by means of two-point measurement at an electrode separation of 2 mm (Multimeter: Metra Hit One Plus, Gossen Metrawatt GmbH). The results presented in FIG. 4 show a good electrical conductivity of the semicrystalline polyurethane-CNT mixtures with a percolation threshold at about 2.5% by weight of CNT and a comparatively low conductivity of the corresponding Dispercoll U42 composites.

1.-17. (canceled)

18. An electrically conductive polyurethane composition comprising at least one polyurethane polymer and carbonaceous nanoparticles, wherein the at least one polyurethane polymer has a substantial portion of semicrystalline polyurethane, and wherein the carbonaceous nanoparticles comprise at least 20% carbon nanotubes.

19. The electrically conductive polyurethane composition according to claim 18, wherein the at least one polyurethane polymer has at least 10% by weight of semicrystalline polyurethane.

20. The electrically conductive polyurethane composition according to claim 18, wherein the carbonaceous nanoparticles consists essentially of carbon nanotubes.

21. The electrically conductive polyurethane composition according to claim 18, wherein the electrically conductive polyurethane composition comprises at least 0.1% by weight of carbonaceous nanoparticles.

22. The electrically conductive polyurethane composition according to claim 18, wherein the electrically conductive polyurethane composition comprises not more than 8% by weight.

23. The electrically conductive polyurethane composition according to claim 18, wherein the conductivity of the polyurethane composition is at least 1·10⁻⁵ S/cm.

24. The electrically conductive polyurethane composition according to claim 23, wherein the carbonaceous nanoparticles consists of carbon nanotubes, and the proportion of the carbon nanotubes in the composition is not more than 3% by weight.

25. The electrically conductive polyurethane composition according to claim 18, wherein the carbon nanotubes have a ratio of length to external diameter of greater than 5.

26. The electrically conductive polyurethane composition according to claim 18, wherein the carbon nanotubes essentially have a mean diameter of 3 to 100 nm.

27. The electrically conductive polyurethane composition according to claim 18, wherein the carbon nanotubes comprise scroll type carbon nanotubes.

28. The electrically conductive polyurethane composition according to claim 18, wherein the semicrystalline polyurethane is formed from
A. at least one difunctional aliphatic or aromatic polyesterpolyol with a molecular weight of 400 to 5000 g/mol,
B. optionally difunctional or higher-functionality polyol components with a molecular weight of 62 to 399,
C. at least one di- or polyisocyanate component and
D. optionally one or more aminic chain extenders.

29. The electrically conductive polyurethane composition according to claim 18, wherein the semicrystalline polyurethane is based on polyurethane dispersions.

30. The electrically conductive polyurethane composition according to claim 18, wherein the semicrystalline polyurethane is partly crystalline and has, in the DSC analysis, a melting or crystallization peak which corresponds to a melting enthalpy of at least 5 J/g.

31. The electrically conductive polyurethane composition according to claim 18, wherein the polyurethane composition further comprises a filler, a reinforcer, a stabilizer, a dispersant, an additive, or mixtures thereof.

32. A process for producing an electrically conductive polyurethane composition, comprising
a) preparing an aqueous dispersion of carbonaceous nanoparticles,
b) mixing the dispersion of the carbonaceous nanoparticles with an aqueous polyurethane dispersion,
c) removing water from the mixture,
d) hardening the dried product from step c) by applying heat,
wherein the polyurethane dispersion is based on substantial amounts of semicrystalline polyurethane.

33. The process according to claim 32, wherein the polyurethane dispersion is based on at least 20% by weight of semicrystalline polyurethane.

34. The process according to claim 32, wherein, in the preparation of the aqueous dispersion of the carbonaceous nanoparticles a), a surface-active substance is added as a dispersant.

35. The process according to claim 32, wherein the surface-active substance is selected from the group consisting of hydrocarbon sulphates or sulphonates, which includes sodium dodecylsulphonate (SDS), the polyalkylene oxide-based dispersants, the water-dispersible pyrrolidones, or block copolymers which are surface-active in an aqueous medium.

36. The process according to claim 32, wherein the aqueous dispersion is prepared in step a) by employing ultrasound.

37. A coating in motor vehicle construction or a housing of an electrical appliance comprising the polyurethane composition according to claim 18.
